(19) United States
(12) Patent Application Publication
(10) Pub. No.: US 2025/0227518 A1
(43) Pub. Date: Jul. 10, 2025

(54) MODEL DEACTIVATION METHOD AND APPARATUS, INFORMATION SENDING METHOD AND APPARATUS, AND DEVICE

(71) Applicant: VIVO MOBILE COMMUNICATION CO., LTD., Dongguan (CN)

(72) Inventors: Tong ZHOU, Dongguan (CN); Peng SUN, Dongguan (CN); Hao WU, Dongguan (CN)

(21) Appl. No.: 19/094,933

(22) Filed: Mar. 30, 2025

Related U.S. Application Data
(63) Continuation of application No. PCT/CN2023/120928, filed on Sep. 25, 2023.

(30) Foreign Application Priority Data
Sep. 30, 2022 (CN) 202211215844.9

(51) Int. Cl. H04W 24/04

(52) U.S. Cl. CPC H04W 24/04

(57) ABSTRACT

A model deactivation method includes: receiving, by a first device, first information sent by a second device, where the first information is used to indicate information related to a first condition, and the first condition includes: support for a target mapping processing manner; and performing, by the first device, a deactivation operation on an inference model in a case that the first condition is not met, or maintaining, by the first device, the inference model in an activated state or activating the inference model in a case that the first condition is met, where the inference model corresponds to mapped data, and the mapped data is data obtained in the target mapping processing manner.

### CROSS-REFERENCE TO RELATED APPLICATIONS

This application is a bypass continuation application of International Application No. PCT/CN2023/120928, filed on Sep. 25, 2023, which claims the benefit of and priority to Chinese Patent Application No. 202211215844.9, filed on Sep. 30, 2022. The foregoing applications are incorporated by reference in their entireties herein.

### TECHNICAL FIELD

This application relates to the field of communications technologies and, more specifically, relates to a model deactivation method and apparatus, an information sending method and apparatus, and a device.

### BACKGROUND

In some communication systems, a communication device is newly introduced to perform information inference based on an inference model. For example, channel information prediction can be performed based on the inference model, or beam information prediction can be performed based on the inference model. After the inference model is configured for the communication device, the inference model is always in an activated state, that is, the communication device always performs prediction by using the inference model until a communication result of communication performed based on a predicted result of the inference model indicates that prediction performance of the inference model has seriously deteriorated. Thus, a specific process is as follows. Communication is performed based on the predicted result of the inference model, communication is measured, whether the prediction performance of the inference model deteriorates seriously is determined based on a measurement result, and in a case that the prediction performance of the inference model deteriorates seriously, the inference model is deactivated.

### BRIEF SUMMARY

Embodiments of this application provide a model deactivation method and apparatus, an information sending method and apparatus, and a device.

According to a first aspect, a model deactivation method is provided, including:

A first device receives first information sent by a second device, where the first information is used to indicate information related to a first condition, and the first condition includes: support for a target mapping processing manner.

The first device performs a deactivation operation on an inference model in a case that the first condition is not met, where the inference model corresponds to mapped data, and the mapped data is data obtained in the target mapping processing manner.

According to a second aspect, an information sending method is provided, including:

A second device sends first information to a first device, where the first information is used to indicate information related to a first condition, and the first condition includes: support for a target mapping processing manner.

According to a third aspect, a model deactivation apparatus is provided, including:
a receiving module, configured to receive first information sent by a second device, where the first information is used to indicate information related to a first condition, and the first condition includes: support for a target mapping processing manner; and
an operation module, configured to perform a deactivation operation on an inference model in a case that the first condition is not met, where the inference model corresponds to mapped data, and the mapped data is data obtained in the target mapping processing manner.

According to a fourth aspect, an information sending apparatus is provided, including:
a sending module, configured to send first information to a first device, where the first information is used to indicate information related to a first condition, and the first condition includes: support for a target mapping processing manner.

According to a fifth aspect, a communication device is provided. The communication device includes a processor and a memory. The memory stores a program or an instruction that is executable on the processor, and the program or the instruction is executed by the processor to implement the steps of the model deactivation method provided in the embodiments of this application.

According to a sixth aspect, a communication device is provided, including a processor and a communication interface. The communication interface is configured to receive first information sent by a second device, where the first information is used to indicate information related to a first condition, and the first condition includes: support for a target mapping processing manner. The processor is configured to perform a deactivation operation on an inference model, where the inference model corresponds to mapped data, and the mapped data is data obtained in the target mapping processing manner.

According to a seventh aspect, a communication device is provided. The communication device includes a processor and a memory. The memory stores a program or an instruction that is executable on the processor, and the program or the instruction is executed by the processor to implement the steps of the information sending method provided in the embodiments of this application.

According to an eighth aspect, a communication device is provided, including a processor and a communication interface. The communication interface is configured to send first information to a first device, where the first information is used to indicate information related to a first condition, and the first condition includes: support for a target mapping processing manner.

According to a ninth aspect, a model deactivation system is provided, including a first device and a second device. The first device may be configured to perform the steps of the model deactivation method provided in the embodiments of this application, and the second device may be configured to perform the steps of the information sending method provided in the embodiments of this application.

According to a tenth aspect, a readable storage medium is provided. The readable storage medium stores a program or an instruction, and the program or the instruction is executed by a processor to implement the steps of the model deactivation method provided in the embodiments of this application, or implement the steps of the information sending method provided in the embodiments of this application.

According to an eleventh aspect, a chip is provided. The chip includes a processor and a communication interface, the communication interface is coupled to the processor, and the processor is configured to run a program or an instruction to implement the model deactivation method provided in the embodiments of this application, or implement the information sending method provided in the embodiments of this application.

According to a twelfth aspect, a computer program/program product is provided. The computer program/program product is stored in a storage medium, and the computer program/program product is executed by at least one processor to implement the steps of the model deactivation method provided in the embodiments of this application, or the computer program/program product is executed by at least one processor to implement the steps of the information sending method provided in the embodiments of this application.

### BRIEF DESCRIPTION OF DRAWINGS

FIG. 1 is a block diagram of a wireless communication system to which embodiments of this application are applicable;

FIG. 2 is a flowchart of a model deactivation method according to an embodiment of this application;

FIG. 3 is a flowchart of an information sending method according to an embodiment of this application;

FIG. 4 is a structural diagram of a model deactivation apparatus according to an embodiment of this application;

FIG. 5 is a structural diagram of an information sending apparatus according to an embodiment of this application;

FIG. 6 is a structural diagram of a communication device according to an embodiment of this application;

FIG. 7 is a structural diagram of another communication device according to an embodiment of this application; and

FIG. 8 is a structural diagram of another communication device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} generation (6G) communication system.

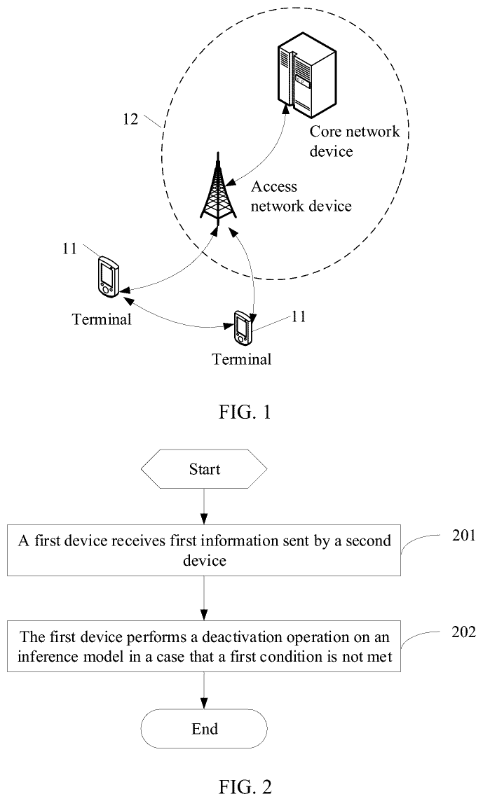

FIG. 1 is a block diagram of a wireless communication system to which embodiments of this application are applicable. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. In addition to the terminal device, the terminal 11 may be a chip in the terminal, such as a modem chip or a System on Chip (SoC). It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a local NEF (or L-NEF), a Binding Support Function (BSF), an Application Function (AF), and the like. It should be noted that, in the embodiments of this application, only a core network device in an NR system is used as an example for description, and a specific type of the core network device is not limited.

In some communication systems, a communication device is newly introduced to perform information inference based on an inference model. For example, channel information prediction is performed based on the inference model, or beam information prediction is performed based on the inference model. After the inference model is configured for the communication device, the inference model is always in an activated state, that is, the communication device always performs prediction by using the inference model until a communication result of communication performed based on a predicted result of the inference model indicates that prediction performance of the inference model deteriorates seriously. A specific process is as follows. Communication is performed based on the predicted result of the inference model, communication is measured, whether the prediction performance of the inference model deteriorates seriously is determined based on a measurement result, and in a case that the prediction performance of the inference model deteriorates seriously, the inference model is deactivated. In this way, because the inference model is deactivated only when the predicted result of the inference model indicates serious deterioration, the prediction performance of the inference model is poor.

Embodiments of this application provide a model deactivation method and apparatus, an information sending method and apparatus, and a device, so that poor prediction performance of an inference model can be resolved among other potential benefits.

With reference to the accompanying drawings, the following describes in detail a model deactivation method and apparatus, an information sending method and apparatus, and a device provided in the embodiments of this application by using some embodiments and application scenarios thereof.

Referring to FIG. 2. FIG. 2 is a flowchart of a model deactivation method according to an embodiment of this application. As shown in FIG. 2, the method includes the following steps.

Step 201: A first device receives first information sent by a second device, where the first information is used to indicate information related to a first condition, and the first condition includes: support for a target mapping processing manner.

In some implementations, the first device may be a terminal, and the second device may be a network side device or a terminal.

In some implementations, the first device may be a network side device, and the second device may be a network side device or a terminal.

The first information includes information about an object meeting the first condition, for example, a cell, a network side device, or a terminal meeting the first condition.

The support for the target mapping processing manner may be support for performing model inference by using mapped data obtained in the supported target mapping processing manner, or the support for the target mapping processing manner may be support for provision of mapped data obtained in the target mapping processing manner.

The target mapping processing manner may be a mapping processing manner determined by the first device, or may be a mapping processing manner indicated by the second device. In some implementations, the target mapping processing manner may be a mapping processing manner determined by a third device, where the third device is a device providing the mapped data or a mapping processing device. For example, the third device performs mapping processing on collected data in the target mapping processing manner to obtain the mapped data. The third device may be specifically a network side device or a terminal.

In addition, the target mapping processing manner may include one or more types of mapping processing.

In this embodiment of this application, the mapping processing manner means that mapping processing is performed on data to avoid data exposure, so that processed data has higher security. In addition, the mapping processing may also be referred to as privacy-protected processing, privacy processing, data mapping processing, information mapping processing, or the like. The mapping processing manner may also be referred to as a privacy-protected processing manner, a privacy processing manner, a data mapping processing manner, an information mapping processing manner, or the like. A specific name is not limited.

Step 202: The first device performs a deactivation operation on an inference model in a case that the first condition is not met, where the inference model corresponds to mapped data, and the mapped data is data obtained in the target mapping processing manner.

The mapped data may be data obtained by the third device or the second device by performing mapping processing on data in the target mapping processing manner, for example, data obtained by the third device or the second device by performing mapping processing on the collected data in the target mapping processing manner.

That the inference model corresponds to mapped data may be that the inference model is used to perform inference or prediction based on the mapped data, for example, perform beam information (such as receive beam and/or transmit beam) prediction based on the collected data, or perform channel information prediction based on the mapped data.

That the first device performs a deactivation operation on an inference model in a case that the first condition is not met may be that the inference model is deactivated in the case that the first condition is not met. Alternatively, that the first device performs a deactivation operation on an inference model in a case that the first condition is not met may be that in the case that the first condition is not met, the inference model is maintained in a deactivated state in a case that the inference model is in the deactivated state.

In addition, in a case that the first condition is met, the inference model is maintained in an activated state, or the inference model is activated.

That the first condition is not met may be that a current serving cell of the first device does not meet the first condition, or a network side device serving the first device does not meet the first condition, or a location area or a scenario that the first device is in does not meet the first condition, or the first device does not meet the first condition.

In some implementations, that the first device performs a deactivation operation on an inference model in a case that the first condition is not met may be that the first device determines an inferable range of the inference model based on the first information, deactivates the inference model outside the range, and activates the inference model within the range.

It should be noted that the data in this embodiment of this application may alternatively be information. For example, the mapped data may also be referred to as mapped information, and the collected data may also be referred to as collected information or gathered information.

In this embodiment of this application, through the foregoing steps, in this way, the inference model can be deactivated in the case that the first condition is not met, to avoid deterioration of the prediction performance of the inference model and further improve the prediction performance of the inference model. For example, the inference model is prevented from performing prediction based on data other than the mapped data.

In an optional implementation, the information related to the first condition includes at least one of the following:
a list of an object meeting the first condition, where the object includes at least one of the following:
a cell, a core network function, a network function, and a terminal.

The core network function may also be referred to as a core network device.

The network function may be a radio access network function, and may also be referred to as a radio access network device.

The list of the object may include at least one of the following:
a list of cells, a list of core network functions, a list of network functions, or a list of terminals.

The cell meeting the first condition means that a first set of the cell includes a first identifier of the target mapping processing manner, the first set is a set of a first mapping relationship, and the first mapping relationship is a mapping relationship between a mapping processing manner and an identifier.

The first set of the cell may include a set of one or more first mapping relationships configured for the foregoing first cell.

The core network function meeting the first condition means that a first set of the core network function includes a first identifier of the target mapping processing manner, the first set is a set of a first mapping relationship, and the first mapping relationship is a mapping relationship between a mapping processing manner and an identifier.

The first set of the core network function may include a set of one or more first mapping relationships stored in the core network function or configured for the core network function.

The network function meeting the first condition means that a first set of the network function includes a first identifier of the target mapping processing manner, the first set is a set of a first mapping relationship, and the first mapping relationship is a mapping relationship between a mapping processing manner and an identifier.

The first set of the network function may include a set of one or more first mapping relationships stored in the network function or configured for the network function.

The terminal meeting the first condition means that a first set of the terminal includes a first identifier of the target mapping processing manner, the first set is a set of a first mapping relationship, and the first mapping relationship is a mapping relationship between a mapping processing manner and an identifier.

The first set of the terminal may include a set of one or more first mapping relationships stored in the terminal or configured for the terminal.

In the foregoing implementation, whether the first condition is met may be determined based on whether the first identifier is included in the corresponding first set.

Optionally, that the first device performs a deactivation operation on an inference model in a case that the first condition is not met may include at least one of the following:
in a case that the list of the object does not include a target cell of the first device, deactivating the inference model in a case that the first device is handed over to the target cell;
in a case that the list of the object does not include a current serving cell of the first device, deactivating, by the first device, the inference model;
in a case that the list of the object does not include a target network function of the first device, deactivating the inference model in a case that the first device is handed over to the target network function; or
in a case that the list of the object does not include a current serving network function of the first device, deactivating, by the first device, the inference model.

The target cell is a target cell in a process in which the first device performs cell handover, to deactivate the inference model in the handover process.

The target network function is a network function corresponding to the target cell in the process in which the first device performs cell handover, to deactivate the inference model in the handover process.

In the implementation, the inference model can be deactivated in a case that the target cell, the current serving cell, the target network function, and the current serving network function do not meet the first condition.

In some implementations, the inference model can alternatively be deactivated in a case that the terminal corresponding to the first device is a terminal in the list of the object. For example, in a case that the terminal that accesses the network function is a terminal in the list of the object, the network function deactivates the inference model.

In some implementations, the list of the object meeting the first condition may be determined through information exchange between the second device and at least one device, where the information exchange may be used to determine at least one of the following:
a cell meeting the first condition, a core network function meeting the first condition, a network function meeting the first condition, or a terminal meeting the first condition.

For example, after the second device determines the target mapping processing manner, in a case that the second device and the third device are both base stations of an access network, the first information is obtained by exchanging the first condition through an interface between the base stations.

For another example, in a case that the third device is an access network function and the second device is a core network function, the second device obtains the first information by exchanging the first condition through an interface between the access network and the core network.

For another example, in a case that the second device and the third device are both core network functions, the second device obtains the first information by exchanging the first condition through an interface between the core network functions.

For another example, in a case that the second device and the third device are terminals, the terminal may feedback whether the terminal meets the first condition. In a case that the first condition is met, an identifier of the terminal or an Acknowledgement (ACK) is fed back. In a case that the first condition is not met, that a set satisfying the first condition is empty is fed back.

In an optional implementation, the method further includes:

The first device sends a first message to the second device, where the first message includes a first identifier, and the first identifier is used to indicate the target mapping processing manner.

In the implementation, the first device can indicate the target mapping processing manner to the second device.

The first identifier may be referred to as a mapping identifier, a privacy identifier, a privacy processing identifier, a data collection identifier, a data gather identifier, or a data processing identifier.

Because the first identifier is used to indicate the target mapping processing manner, the inference model may also be referred to as the inference model corresponding to the first identifier.

In addition, the first information may be determined by the second device based on the first identifier and sent to the first device.

In some implementations, the second device may determine the to-be-used target mapping processing manner according to the first identifier, for example, the mapping processing manners include mapping manners 1 to 5, so that a mapping manner or a combination of mapping manners is determined from the mapping manners 1 to 5 according to the first identifier, and a transformation operation and a parameter configuration in each mapping manner can also be determined.

For example, at least one of the following is determined based on the first identifier:
the mapping manners 1 and 5 are used;
the mapping manner 1 uses a bias value: 100; and
the mapping manner 5 uses an disordering operation: 4 3 1 5 6 7 8 2.

100 is a parameter configuration of the mapping manner 1, and a transformation order 4, 3, 1, 5, 6, 7, 8, 2 is a parameter configuration of the mapping manner 5. A combination of a plurality of mapping manners may be used for a data object. A mapping identifier may include mapping processing on a plurality of data objects. In a case that a same mapping manner but different parameter configurations are used for a data object, different mapping identifiers are used.

Optionally, the first message further includes a data collection requirement, where the data collection requirement corresponds to the target mapping processing manner.

The data collection requirement may indicate a type, an amount, and a collection configuration of data to be collected.

That the data collection requirement corresponds to the target mapping processing manner may be that the collected data collected according to the data collection requirement is processed in the target mapping processing manner or mapping processing is performed in the target mapping processing manner on the collected data collected according to the data collection requirement.

In some implementations, the data collection requirement may include at least one of the following:
a data collection object and a collection quantity.

The data collection object may include at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight (LOS) distribution information; and
cell non-line-of-sight (NLOS) distribution information.

In some implementations, the width of the beam in the horizontal direction may be a 3 dB, 1 dB, or 6 dB beam width of the beam in the horizontal direction, the width of the beam in the vertical direction may be a 3 dB, 1 dB, or 6 dB beam width of the beam in the vertical direction, and the beam gain may be a beam gain at an interval of 5 degrees, 10 degrees, or the like in a beam direction pointing to a center.

The collection quantity may include at least one of the following:
a quantity of beams, a quantity of terminals, a quantity of network functions, or a quantity of cells.

Optionally, the collected data corresponding to the data collection requirement is collected by the third device according to the data collection requirement.

In the implementation, data collection can be implemented as the data collection requirement oriented to the third device. In addition, in the implementation, the inference model may be used to perform inference on the mapped data corresponding to the collected data. For example, the third device obtains the collected data according to the data collection requirement, performs mapping processing on the collected data in the target mapping processing manner to obtain the mapped data, and provides the mapped data for the first device. The inference model performs beam information or channel information prediction based on the mapped data. In addition, the third device may provide the mapped data within a range within which the first condition is met.

In an optional implementation, the target mapping processing manner includes at least one of the following:
bias processing;
scaling processing;
function transformation processing;
multidimensional mapping processing;
disordering processing; and
quantization mapping processing.

In some implementations, the target mapping processing manner is known to the third device and is unknown to the first device. In this way, data security can be further improved, but this is not limited. For example, in some scenarios or implementations, the target mapping processing manner is known to the first device.

The bias processing may be to perform bias processing on data according to a bias value, where the bias value is known to the third device and is unknown to the first device.

The scaling processing may be to perform reduction or enlargement processing on data according to a scaling value, where a scaling multiple is known to the third device and is unknown or known to the first device.

The function transformation processing may be to perform an operation on data used as a variable of a function, where the function used for transformation is known to the third device and is unknown or known to the first device.

The multidimensional mapping processing may be to map one piece of data to a plurality of pieces of data, where a mapping method is known to the third device and is unknown or known to the first device.

The bias processing, the scaling processing, the function transformation processing, and the multidimensional mapping processing may be shown in the following Table 1:

TABLE 1

| No | Mapping processing manner | Example |
|---|---|---|
| 1 | Bias processing (perform bias | Original value: 10 |
| | on a value) | Bias value: 100 |
| | | After bias: −90 |
| 2 | Scaling processing (perform | Original value: 100 |
| | scaling on a value) | Scaling value: 0.1 |
| | | After scaling: 10 |
| 3 | Function transformation | Original value: 10 |
| | processing (perform | Transformation polynomial: f(x) = 2x\hat{ }3 + 5 |
| | polynomial function | After transformation: 2005 |
| | transformation on a value) | |
| 4 | Multidimensional mapping | Original value: 10 |
| | processing (perform | Multidimensional mapping: (0.1x + 2), (0.5x + 6) |
| | multidimensional mapping on | After mapping: (3, 11) |
| | a single value) | |

The disordering processing may be to perform an disordering operation on a group of values, where a mapping relationship between an original order and an disordering is known to the third device and is unknown or known to the first device, for example, as shown in the following Table 2:

TABLE 2

| No | Original order physical meaning | Original order value |
|---|---|---|
| 1 | Measure a horizontal direction | −70 |
| | orientation of a beam1 (beam1) | |
| 2 | Measure a horizontal direction | −20 |
| | orientation of a beam2 | |
| 3 | Measure a horizontal direction | 20 |
| | orientation of a beam3 | |
| 4 | Measure a horizontal direction | 70 |
| | orientation of a beam4 | |
| 5 | Measure a vertical direction | 22.5 |
| | orientation of the beam1 | |
| 6 | Measure a vertical direction | 112.5 |
| | orientation of the beam2 | |
| 7 | Measure a vertical direction | 22.5 |
| | orientation of the beam3 | |
| 8 | Measure a vertical direction | 112.5 |
| | orientation of the beam4 | |

Table 2 shows an original order and physical meaning mapping table. In this way, after disordering processing, 4 3 1 5 6 7 8 2 is obtained.

Order and physical meaning mapping after the disordering processing may be shown in the following Table 3:

TABLE 3

| No | Original order physical meaning | Original order value |
|---|---|---|
| 1 | Measure a horizontal direction | 70 |
| | orientation of a beam4 | |
| 2 | Measure a horizontal direction | 20 |
| | orientation of a beam3 | |
| 3 | Measure a horizontal direction | −70 |
| | orientation of a beam1 | |
| 4 | Measure a vertical direction | 22.5 |
| | orientation of the beam1 | |
| 5 | Measure a vertical direction | 112.5 |
| | orientation of a beam2 | |
| 6 | Measure a vertical direction | 22.5 |
| | orientation of the beam3 | |
| 7 | Measure a vertical direction | 112.5 |
| | orientation of the beam4 | |
| 8 | Measure a horizontal direction | −20 |
| | orientation of the beam2 | |

The quantization mapping processing may be to perform quantization mapping on a single value, or map the beam direction to the virtual beam identifier, or map data to an identifier, and the mapping relationship is known to the third device and is unknown or known to the first device. For example, mapping to the virtual beam identifier is performed according to the beam direction, or the virtual beam identifier is determined according to both the horizontal direction and the vertical direction, as shown in following Table 4:

TABLE 4

| Horizontal beam | Vertical beam | Virtual beam |
|---|---|---|
| direction | direction | identifier |
| −70 | 22.5 | 0 |
| −70 | 110.5 | 1 |
| −20 | 22.5 | 2 |
| −20 | 110.5 | 3 |
| 20 | 22.5 | 4 |
| 20 | 110.5 | 5 |
| 70 | 22.5 | 6 |
| 70 | 110.5 | 7 |

As shown in Table 4, in a case that for the beam direction, the horizontal direction is −20 and the vertical direction is 110.5, the virtual beam identifier is 3.

Another mapping manner is to separately perform mapping according to the horizontal direction and the vertical direction, as shown in following Table 5 or Table 6:

TABLE 5

| Horizontal beam direction | Virtual beam indicator 1 |
|---|---|
| −70 | 0 |
| −20 | 1 |
| 20 | 2 |
| 70 | 3 |

TABLE 6

| Vertical beam direction | Virtual beam indicator 2 |
|---|---|
| 22.5 | 0 |
| 110.5 | 1 |

As shown in Table 5 and Table 6, in a case that for the beam direction, the horizontal direction is −20 and the vertical direction is 110.5, the virtual beam identifier is (1, 1).

In this embodiment of this application, the first device receives the first information sent by the second device, where the first information is used to indicate the information related to the first condition, and the first condition includes: support for the target mapping processing manner. The first device performs the deactivation operation on the inference model in the case that the first condition is not met, where the inference model corresponds to the mapped data, and the mapped data is the data obtained in the target mapping processing manner. In this way, the inference model can be deactivated in the case that the first condition is not met, to avoid deterioration of the prediction performance of the inference model and further improve the prediction performance of the inference model.

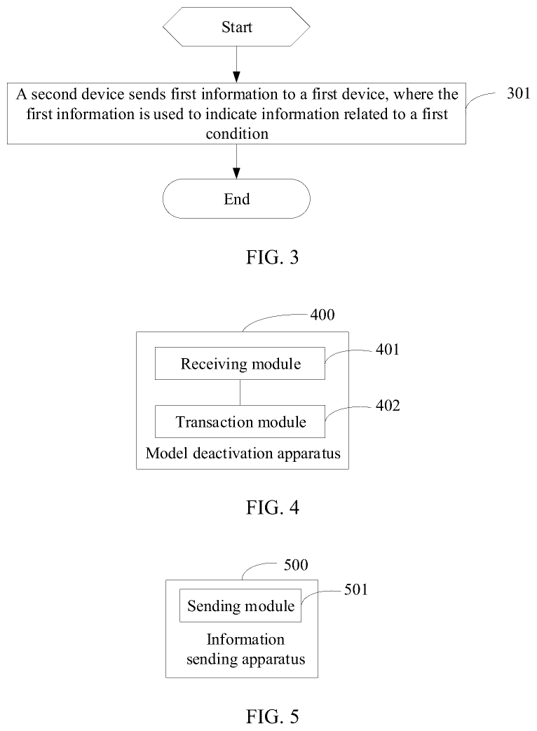

Refer to FIG. 3. FIG. 3 is a flowchart of another information sending method according to an embodiment of this application. As shown in FIG. 3, the method includes the following steps.

Step 301: A second device sends first information to a first device, where the first information is used to indicate information related to a first condition, and the first condition includes: support for a target mapping processing manner.

Optionally, the information related to the first condition includes at least one of the following:
a list of an object meeting the first condition, where the object includes at least one of the following:
a cell, a core network function, a network function, and a terminal.

Optionally, the method further includes:

The second device performs information exchange with at least one device, where the information exchange is used to determine at least one of the following:
a cell meeting the first condition, a core network function meeting the first condition, a network function meeting the first condition, or a terminal meeting the first condition.

Optionally, the cell meeting the first condition means that a first set of the cell includes a first identifier of the target mapping processing manner; and/or
the core network function meeting the first condition means that a first set of the core network function includes a first identifier of the target mapping processing manner; and/or
the network function meeting the first condition means that a first set of the network function includes a first identifier of the target mapping processing manner; and/or
the terminal meeting the first condition means that a first set of the terminal includes a first identifier of the target mapping processing manner, where
the first set is a set of a first mapping relationship, and the first mapping relationship is a mapping relationship between a mapping processing manner and an identifier.

Optionally, the method further includes:

The second device receives a first message sent by the first device, where the first message includes a first identifier, and the first identifier is used to indicate the target mapping processing manner.

The second device determines the first condition based on the first message.

Optionally, the first message further includes a data collection requirement, where the data collection requirement corresponds to the target mapping processing manner.

Optionally, the data collection requirement includes at least one of the following:
a data collection object and a collection quantity.

Optionally, the data collection object includes at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; and
cell non-line-of-sight NLOS distribution information.

Optionally, collected data corresponding to the data collection requirement is collected by a third device according to the data collection requirement.

Optionally, the target mapping processing manner includes at least one of the following:
bias processing;
scaling processing;
function transformation processing;
multidimensional mapping processing;
disordering processing; and
quantization mapping processing.

It should be noted that this embodiment is used as an implementation of the second device corresponding to the embodiment shown in FIG. 2. For a specific implementation, refer to the related descriptions of the embodiment shown in FIG. 2. To avoid repeated description, details are not described again in this embodiment.

Refer to FIG. 4. FIG. 4 is a structural diagram of a model deactivation apparatus according to an embodiment of this application. As shown in FIG. 4, the model deactivation apparatus 400 includes:
a receiving module 401, configured to receive first information sent by a second device, where the first information is used to indicate information related to a first condition, and the first condition includes: support for a target mapping processing manner; and
an operation module 402, configured to perform a deactivation operation on an inference model in a case that the first condition is not met, where the inference model corresponds to mapped data, and the mapped data is data obtained in the target mapping processing manner.

Optionally, the information related to the first condition includes at least one of the following:
a list of an object meeting the first condition, where the object includes at least one of the following:
a cell, a core network function, a network function, and a terminal.

Optionally, the operation module 402 is configured to perform at least one of the following:
in a case that the list of the object does not include a target cell of the first device, deactivating the inference model in a case that the first device is handed over to the target cell;
in a case that the list of the object does not include a current serving cell of the first device, deactivating, by the first device, the inference model;
in a case that the list of the object does not include a target network function of the first device, deactivating the inference model in a case that the first device is handed over to the target network function; or
in a case that the list of the object does not include a current serving network function of the first device, deactivating, by the first device, the inference model.

Optionally, the cell meeting the first condition means that a first set of the cell includes a first identifier of the target mapping processing manner; and/or
the core network function meeting the first condition means that a first set of the core network function includes a first identifier of the target mapping processing manner; and/or
the network function meeting the first condition means that a first set of the network function includes a first identifier of the target mapping processing manner; and/or
the terminal meeting the first condition means that a first set of the terminal includes a first identifier of the target mapping processing manner, where
the first set is a set of a first mapping relationship, and the first mapping relationship is a mapping relationship between a mapping processing manner and an identifier.

Optionally, the apparatus further includes:
a sending module, configured to send a first message to the second device, where the first message includes a first identifier, and the first identifier is used to indicate the target mapping processing manner.

Optionally, the first message further includes a data collection requirement, where the data collection requirement corresponds to the target mapping processing manner.

Optionally, the data collection requirement includes at least one of the following:
a data collection object and a collection quantity.

Optionally, the data collection object includes at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; and
cell non-line-of-sight NLOS distribution information.

Optionally, collected data corresponding to the data collection requirement is collected by a third device according to the data collection requirement.

Optionally, the target mapping processing manner includes at least one of the following:
bias processing;
scaling processing;
function transformation processing;
multidimensional mapping processing;
disordering processing; and
quantization mapping processing.

The model deactivation apparatus can improve prediction performance of the inference model.

The model deactivation apparatus in this embodiment of this application may be an electronic device, for example, an electronic device with an operating system, or may be a component in the electronic device, for example, an integrated circuit or a chip. For example, the electronic device may be a terminal, or another device other than the terminal. For example, the terminal may include but is not limited to the types of the terminal listed in this embodiment of this application, and the another device may be a server, a Network Attached Storage (NAS), or the like. This is not specifically limited in this embodiment of this application.

The model deactivation apparatus provided in this embodiment of this application can implement the processes implemented in the method embodiment shown in FIG. 2, and a same technical effect can be achieved. To avoid repetition, details are not described herein again.

Refer to FIG. 5. FIG. 5 is a structural diagram of an information sending apparatus according to an embodiment of this application. As shown in FIG. 5, the information sending apparatus 500 includes:
a sending module 501, configured to send first information to a first device, where the first information is used to indicate information related to a first condition, and the first condition includes: support for a target mapping processing manner.

Optionally, the information related to the first condition includes at least one of the following:
a list of an object meeting the first condition, where the object includes at least one of the following:
a cell, a core network function, a network function, and a terminal.

Optionally, the apparatus further includes:
an exchange module, configured to perform information exchange with at least one device, where the information exchange is used to determine at least one of the following:
the cell meeting the first condition, the core network function meeting the first condition, the network function meeting the first condition, or the terminal meeting the first condition.

Optionally, the cell meeting the first condition means that a first set of the cell includes a first identifier of the target mapping processing manner; and/or
the core network function meeting the first condition means that a first set of the core network function includes a first identifier of the target mapping processing manner; and/or
the network function meeting the first condition means that a first set of the network function includes a first identifier of the target mapping processing manner; and/or
the terminal meeting the first condition means that a first set of the terminal includes a first identifier of the target mapping processing manner, where
the first set is a set of a first mapping relationship, and the first mapping relationship is a mapping relationship between a mapping processing manner and an identifier.

Optionally, the apparatus further includes:
a receiving module, configured to receive a first message sent by the first device, where the first message includes a first identifier, and the first identifier is used to indicate the target mapping processing manner; and
a determining module, configured to determine the first condition based on the first message.

Optionally, the first message further includes a data collection requirement, where the data collection requirement corresponds to the target mapping processing manner.

Optionally, the data collection requirement includes at least one of the following:
a data collection object and a collection quantity.

Optionally, the data collection object includes at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; and
cell non-line-of-sight NLOS distribution information.

Optionally, collected data corresponding to the data collection requirement is collected by a third device according to the data collection requirement.

Optionally, the target mapping processing manner includes at least one of the following:
bias processing;
scaling processing;
function transformation processing;
multidimensional mapping processing;
disordering processing; and
quantization mapping processing.

The information sending apparatus can improve prediction performance of the inference model.

The information sending apparatus in this embodiment of this application may be an electronic device, for example, an electronic device with an operating system, or may be a component in the electronic device, for example, an integrated circuit or a chip. The electronic device may be a terminal or a network side device.

The information sending apparatus provided in this embodiment of this application can implement the processes implemented in the method embodiment shown in FIG. 3, and a same technical effect can be achieved. To avoid repetition, details are not described herein again.

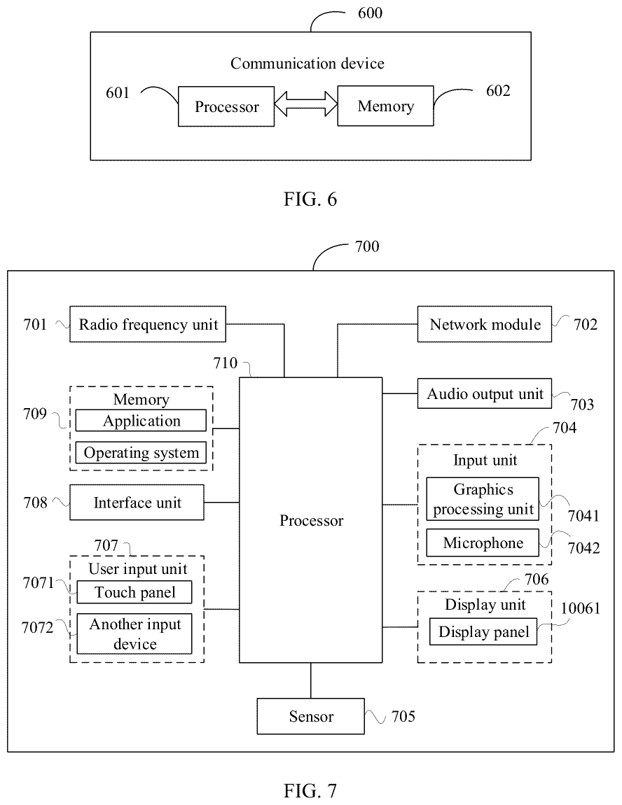

Optionally, as shown in FIG. 6, an embodiment of this application further provides a communication device 600, including a processor 601 and a memory 602. The memory 602 stores a program or an instruction that is executable on the processor 601. For example, in a case that the communication device 600 is a first device, the program or the instruction is executed by the processor 601 to implement the steps of the embodiment of the model deactivation method, and a same technical effect can be achieved. In a case that the communication device 600 is a second device, the program or the instruction is executed by the processor 601 to implement the steps of the embodiment of the information sending method, and a same technical effect can be achieved. To avoid repetition, details are not described herein again.

An embodiment of this application further provides a communication device, including a processor and a communication interface. The communication interface is configured to receive first information sent by a second device, where the first information is used to indicate information related to a first condition, and the first condition includes: support for a target mapping processing manner. The processor is configured to perform a deactivation operation on an inference model, where the inference model corresponds to mapped data, and the mapped data is data obtained in the target mapping processing manner. The embodiment of the communication device corresponds to the foregoing embodiment of the model deactivation method. Each implementation process and implementation of the foregoing method embodiment are applicable to the embodiment of the communication device, and a same technical effect can be achieved.

Specifically, FIG. 7 is a schematic diagram of a hardware structure of a communication device for implementing embodiments of this application.

The communication device 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the communication device 700 may further include a power supply (such as a battery) that supplies power to each component. The power supply may be logically connected to the processor 710 by using a power supply management system, to implement functions such as charging and discharging management, and power consumption management by using the power supply management system. The structure of the communication device shown in FIG. 7 does not constitute a limitation on the communication device. The communication device may include components more or fewer than those shown in the diagram, a combination of some components, or different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still picture or a video obtained by an image capture apparatus (such as a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

In this embodiment, the communication device is a first device, and an example in which the first device is a terminal is used for description.

The radio frequency unit 701 is configured to receive first information sent by a second device, where the first information is used to indicate information related to a first condition, and the first condition includes: support for a target mapping processing manner.

The processor 710 is configured to perform a deactivation operation on an inference model in a case that the first condition is not met, where the inference model corresponds to mapped data, and the mapped data is data obtained in the target mapping processing manner.

Optionally, the information related to the first condition includes at least one of the following:
a list of an object meeting the first condition, where the object includes at least one of the following:
a cell, a core network function, a network function, and a terminal.

Optionally, the performing a deactivation operation on an inference model in a case that the first condition is not met includes at least one of the following:
in a case that the list of the object does not include a target cell of the first device, deactivating the inference model in a case that the first device is handed over to the target cell;
in a case that the list of the object does not include a current serving cell of the first device, deactivating the inference model;
in a case that the list of the object does not include a target network function of the first device, deactivating the inference model in a case that the first device is handed over to the target network function; or
in a case that the list of the object does not include a current serving network function of the first device, deactivating the inference model.

Optionally, the cell meeting the first condition means that a first set of the cell includes a first identifier of the target mapping processing manner; and/or
the core network function meeting the first condition means that a first set of the core network function includes a first identifier of the target mapping processing manner; and/or
the network function meeting the first condition means that a first set of the network function includes a first identifier of the target mapping processing manner; and/or
the terminal meeting the first condition means that a first set of the terminal includes a first identifier of the target mapping processing manner, where
the first set is a set of a first mapping relationship, and the first mapping relationship is a mapping relationship between a mapping processing manner and an identifier.

Optionally, the radio frequency unit 701 is further configured to:
send a first message to the second device, where the first message includes a first identifier, and the first identifier is used to indicate the target mapping processing manner.

Optionally, the first message further includes a data collection requirement, where the data collection requirement corresponds to the target mapping processing manner.

Optionally, the data collection requirement includes at least one of the following:
a data collection object and a collection quantity.

Optionally, the data collection object includes at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; and
cell non-line-of-sight NLOS distribution information.

Optionally, collected data corresponding to the data collection requirement is collected by a third device according to the data collection requirement.

Optionally, the target mapping processing manner includes at least one of the following:
bias processing;
scaling processing;
function transformation processing;
multidimensional mapping processing;
disordering processing; and
quantization mapping processing.

The communication device can improve prediction performance of the inference model.

An embodiment of this application further provides a communication device, including a processor and a communication interface. The communication interface is configured to send first information to a first device, where the first information is used to indicate information related to a first condition, and the first condition includes: support for a target mapping processing manner. The embodiment of the communication device corresponds to the foregoing embodiment of the information sending method. Each implementation process and implementation of the foregoing method embodiment are applicable to the embodiment of the communication device, and a same technical effect can be achieved.

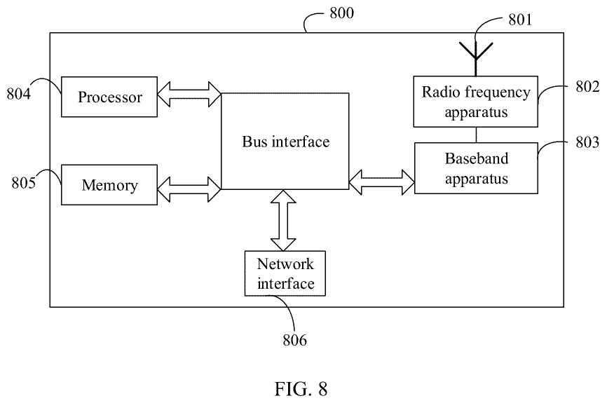

Specifically, an embodiment of this application further provides a communication device. As shown in FIG. 8, the communication device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the communication device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The communication device may further include a network interface 806, and the interface is, for example, a common public radio interface (CPRI).

Specifically, the communication device 800 in this embodiment of the present invention further includes an instruction or a program that is stored in the memory 805 and that is executable on the processor 804. The processor 804 invokes the instruction or the program in the memory 805 to perform the method performed by the modules shown in FIG. 5, and a same technical effect is achieved. To avoid repetition, details are not described herein again.

In this embodiment, the communication device is a second device, an example in which the second device is a radio access network device is used for description.

The radio frequency apparatus 802 is configured to send first information to a first device, where the first information is used to indicate information related to a first condition, and the first condition includes: support for a target mapping processing manner.

Optionally, the information related to the first condition includes at least one of the following:
a list of an object meeting the first condition, where the object includes at least one of the following:
a cell, a core network function, a network function, and a terminal.

Optionally, the radio frequency apparatus 802 is further configured to:
perform information exchange with at least one device, where the information exchange is used to determine at least one of the following:
the cell meeting the first condition, the core network function meeting the first condition, the network function meeting the first condition, or the terminal meeting the first condition.

Optionally, the cell meeting the first condition means that a first set of the cell includes a first identifier of the target mapping processing manner; and/or
the core network function meeting the first condition means that a first set of the core network function includes a first identifier of the target mapping processing manner; and/or
the network function meeting the first condition means that a first set of the network function includes a first identifier of the target mapping processing manner; and/or
the terminal meeting the first condition means that a first set of the terminal includes a first identifier of the target mapping processing manner, where
the first set is a set of a first mapping relationship, and the first mapping relationship is a mapping relationship between a mapping processing manner and an identifier.

Optionally, the radio frequency apparatus 802 is further configured to:
receive a first message sent by the first device, where the first message includes a first identifier, and the first identifier is used to indicate the target mapping processing manner.

The processor 804 is configured to determine the first condition based on the first message.

Optionally, the first message further includes a data collection requirement, where the data collection requirement corresponds to the target mapping processing manner.

Optionally, the data collection requirement includes at least one of the following:
a data collection object and a collection quantity.

Optionally, the data collection object includes at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; and
cell non-line-of-sight NLOS distribution information.

Optionally, collected data corresponding to the data collection requirement is collected by a third device according to the data collection requirement.

Optionally, the target mapping processing manner includes at least one of the following:
bias processing;
scaling processing;
function transformation processing;
multidimensional mapping processing;
disordering processing; and
quantization mapping processing.

The communication device can improve prediction performance of the inference model.

An embodiment of this application further provides a readable storage medium. The readable storage medium stores a program or an instruction, and the program or the instruction is executed by a processor to implement the steps of the model deactivation method or the information sending method provided in the embodiments of this application.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or an instruction to implement the processes of the embodiment of the model deactivation method or the information sending method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the embodiment of the model deactivation method or the information sending method, and a same technical effect can be achieved. To avoid repetition, details are not described herein again.

An embodiment of this application further provides a model deactivation system, including a first device and a second device. The first device may be configured to perform the steps of the model deactivation method provided in the embodiments of this application, and the second device may be configured to perform the steps of the information sending method provided in the embodiments of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a desirable implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A model deactivation method, comprising:
receiving, by a first device, first information sent by a second device, wherein the first information is used to indicate information related to a first condition, and the first condition comprises support for a target mapping processing manner; and
performing, by the first device, a deactivation operation on an inference model in a case that the first condition is not met; or maintaining the inference model in an activated state or activating the inference model in a case that the first condition is met,
wherein the inference model corresponds to mapped data, and the mapped data is data obtained in the target mapping processing manner.

2. The method according to claim 1, wherein the first device is a first network side device, and the second device is a second network side device or a terminal.

3. The method according to claim 1, wherein the information related to the first condition comprises:
an object list meeting the first condition, wherein an object in the object list comprises at least one of the following:
a cell, a core network function, a network function, or a terminal.

4. The method according to claim 3, wherein the performing, by the first device, a deactivation operation on an inference model in a case that the first condition is not met comprises at least one of the following:
in a case that the object list does not comprise a target cell of the first device, deactivating the inference model in a case that the first device is handed over to the target cell;
in a case that the object list does not comprise a current serving cell of the first device, deactivating, by the first device, the inference model;
in a case that the object list does not comprise a target network function of the first device, deactivating the inference model in a case that the first device is handed over to the target network function; or
in a case that the object list does not comprise a current serving network function of the first device, deactivating, by the first device, the inference model.

5. The method according to claim 3, wherein the cell meeting the first condition means that a first set of the cell comprises a first identifier of the target mapping processing manner; and/or
the core network function meeting the first condition means that a first set of the core network function comprises a first identifier of the target mapping processing manner; and/or
the network function meeting the first condition means that a first set of the network function comprises a first identifier of the target mapping processing manner; and/or
the terminal meeting the first condition means that a first set of the terminal comprises a first identifier of the target mapping processing manner, wherein
the first set is a set of a first mapping relationship, and the first mapping relationship is a mapping relationship between a mapping processing manner and an identifier.

6. The method according to claim 1, wherein the method further comprises:
sending, by the first device, a first message to the second device, wherein the first message comprises a first identifier, and the first identifier is used to indicate the target mapping processing manner.

7. The method according to claim 6, wherein the first message further comprises a data collection requirement, wherein the data collection requirement corresponds to the target mapping processing manner.

8. The method according to claim 7, wherein the data collection requirement comprises at least one of the following:
a data collection object or a collection quantity.

9. The method according to claim 8, wherein the data collection object comprises at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; or
cell non-line-of-sight NLOS distribution information.

10. An information sending method, comprising:
sending, by a second device, first information to a first device, wherein the first information is used to indicate information related to a first condition, and the first condition comprises support for a target mapping processing manner.

11. The method according to claim 10, wherein the first device is a first network side device, and the second device is a second network side device or a terminal.

12. The method according to claim 10, wherein the information related to the first condition comprises:
an object list meeting the first condition, wherein an object in the object list comprises at least one of the following:
a cell, a core network function, a network function, or a terminal.

13. The method according to claim 12, wherein the method further comprises:
performing, by the second device, information exchange with at least one device, wherein the information exchange is used to determine at least one of the following:
a cell meeting the first condition, a core network function meeting the first condition, a network function meeting the first condition, or a terminal meeting the first condition.

14. The method according to claim 10, wherein the method further comprises:
receiving, by the second device, a first message sent by the first device, wherein the first message comprises a first identifier, and the first identifier is used to indicate the target mapping processing manner; and
determining, by the second device, the first condition based on the first message.

15. The method according to claim 14, wherein the first message further comprises a data collection requirement, wherein the data collection requirement corresponds to the target mapping processing manner.

16. The method according to claim 15, wherein the data collection requirement comprises at least one of the following:
a data collection object or a collection quantity.

17. The method according to claim 16, wherein the data collection object comprises at least one of the following:
a horizontal beam direction of a beam;
a vertical beam direction of the beam;
a width of the beam in a horizontal direction;
a width of the beam in a vertical direction;
a beam gain;
antenna direction information;
a terminal moving speed;
terminal location information;
network function location information;
cell line-of-sight LOS distribution information; or
cell non-line-of-sight NLOS distribution information.

18. The method according to claim 15, wherein collected data corresponding to the data collection requirement is collected by a third device according to the data collection requirement.

19. A communication device, comprising at least one hardware processor and a memory, wherein the memory stores a program or an instruction that is executable on the processor, and the program or the instruction is executed by the processor to implement one or more operations comprising:
receiving first information sent by a second device, wherein the first information is used to indicate information related to a first condition, and the first condition comprises support for a target mapping processing manner; and
performing a deactivation operation on an inference model in a case that the first condition is not met; or maintaining the inference model in an activated state or activating the inference model in a case that the first condition is met,
wherein the inference model corresponds to mapped data, and the mapped data is data obtained in the target mapping processing manner.

20. A communication device, comprising a processor and a memory, wherein the memory stores a program or an instruction that is executable on the processor, and the program or the instruction is executed by the processor to implement the steps of the information sending method according to claim 10.
